(19) United States
(12) Patent Application Publication
(10) Pub. No.: US 2017/0366961 A1
(43) Pub. Date: Dec. 21, 2017

(54) P-VISITED-NETWORK-ID (PVNI) WITH DATA RESTORATION

(71) Applicant: T-Mobile, U.S.A., Inc., Bellevue, WA (US)

(72) Inventor: Nassereddine Sabeur, Bellevue, WA (US)

(21) Appl. No.: 15/480,347

(22) Filed: Apr. 5, 2017

Related U.S. Application Data
(60) Provisional application No. 62/351,248, filed on Jun. 16, 2016.

(51) Int. Cl. H04W 8/08; H04M 15/00; H04W 8/04; H04W 8/06; H04W 64/00; H04W 88/16

(52) U.S. Cl. CPC H04W 8/087; H04W 8/06; H04W 64/00; H04M 15/49; H04W 8/04; H04W 88/16

(57) ABSTRACT

Techniques are disclosed for providing data restoration for a call server control function (S-CSCF) in a telecommunications network that includes a P-Visited-Network-ID (PVNI). In some embodiments, in the course of a user device registering to a telecommunications network, a home subscriber server (HSS) of the network stores a PVNI for the user device. If a S-CSCF that corresponds to the user device later fails, the network is able to restore the S-CSCF using the information in the HSS, which includes the PVNI.

### CROSS-REFERENCE TO RELATED APPLICATIONS

This application claims priority to provisional application, 62/351,248 (attorney docket number TM.P0315US1), filed on Jun. 16, 2016, and titled “P-Visited-Network-Id (PVNI) with Data Restoration,” the contents of which are incorporated herein by reference.

### BACKGROUND

User devices, such as cellular telephones, may connect to a variety of wireless telecommunications networks that are operated by different companies. These telecommunications networks may be cellular networks that operate according to a variety of protocols, such as a Long-Term Evolution (LTE), a Voice Over LTE (VoLTE), or a LTE in unlicensed spectrum (LTE-u) protocol. It may be that a particular user device is associated with a particular network (sometimes called a home network) and that user device may also connect to another network (sometimes called a visited network). This act of a user device connecting to a network other than the user device's home network may be referred to as roaming. When a user device connects to a visited network, there may be communications between the visited network and the home network to register the user device on the visited network.

### BRIEF DESCRIPTION OF THE DRAWINGS

The Detailed Description is set forth with reference to the accompanying Figures.

FIG. 1 is a block diagram of various components of a computing device for implementing the restoration of a P-Visited-Network-ID.

FIG. 2 illustrates an example network architecture for implementing the restoration of a P-Visited-Network-ID, in which a home network is configured to restore a P-Visited-Network-ID for a user device that connects to a visited network.

FIG. 3 depicts a flow diagram of example operating procedures for a user device registering via a visited network where PVNI with data restoration is used.

FIG. 4 depicts a flow diagram of example operating procedures for restoring a S-CSCF where PVNI with data restoration is used.

FIG. 5 depicts a flow diagram of example operating procedures for billing usage of a user device where PVNI with data restoration is used.

### DETAILED DESCRIPTION

### Overview

In the process of a user device registering to a network, a P-Visited-Network-Id (PVNI) may be stored for the user device, which indicates which country the user device is being used in. A user device may be a feature phone, a smartphone, a tablet computer, a phablet, an embedded computer system, or any other device that is capable of using the wireless communication services that are provided by multiple types of communication networks. This PVNI may comprise a two- or three-digit mobile country code (MCC) that identifies a country, or geographical area, in which the user device is being used, and a mobile network code (MNC) that identifies a home network of the user device. A PVNI, which may be referred to as a PVNI header field, may be used to convey an identifier of a visited network to a registrar or home proxy in a home network. The PVNI header may be inserted by a P-CSCF to the REGISTER and forwarded to a S-CSCF to be used for charging and roaming restrictions.

In some network architectures, this PVNI is stored in a Serving Call Session Control Function (S-CSCF), but not in a Home Subscriber Server (HSS). The S-CSCF is then used to handle various functions for the user device, such as determine a billing associated with usage of that user device. A user device's usage billing may vary based on where the user device is located. For example, if the user device is being used on the home network, there may be one billing rate associated with usage. However, if the user device is being used on a visited network in another country, there may be a second, higher, billing rate associated with usage.

Since the S-CSCF generally stores a user device's PVNI, the S-CSCF is able to determine which country or network the user device is being used in or on. However, in many network architectures, while the HSS stores some information about the user device, it generally does not store the PVNI. Thus, if a S-CSCF that corresponds to a user device fails, and another S-CSCF is restored, this new S-CSCF will retrieve information for the old S-CSCF from the HSS, but the PVNI will generally not be included in this information. That is, if a S-CSCF goes down, after a S-CSCF restoration, the PVNI may not be restored as it is not part of restoration data that is stored in an HSS. During this time, profile recovery that is invoked by a TAS, and which is triggered due to an incoming INVITE Request for origination and/or termination, will lack a PVNI. For an origination request, an INVITE may contain a P-access-network-info (PANT) but not a PVNI.

Since the new S-CSCF lacks the user device's PVNI, the new S-CSCF is generally unable to determine how to bill a user device for usage, and will default to treating the user device as though it is using the home network. Since using the home network generally comes with a lower billing than using a visited network, this means that the network may lose out on billing revenue because it cannot determine the proper amount to charge.

In the absence of a PVNI, the serving network may be considered to be a home public land mobile network (HPLMN), which means that any roaming restrictions or charges are waived, and there are no service restrictions, until a PVNI is restored during a subsequent registration attempt. This may occur when both a TAS and a S-CSCF are restarted at the same time.

A solution, then, is to upgrade the above network architecture by storing the PVNI in the HSS. Then, if a S-CSCF fails, a restored S-CSCF may get information about the old S-CSCF from the HSS, and this information from the HSS will include the PVNI. Since the new S-CSCF has the PVNI for the user device, the new S-CSCF is able to properly bill usage of the user device, and billing revenue is not lost when using this approach.

### Exemplary Hardware, Software and Communications Environment

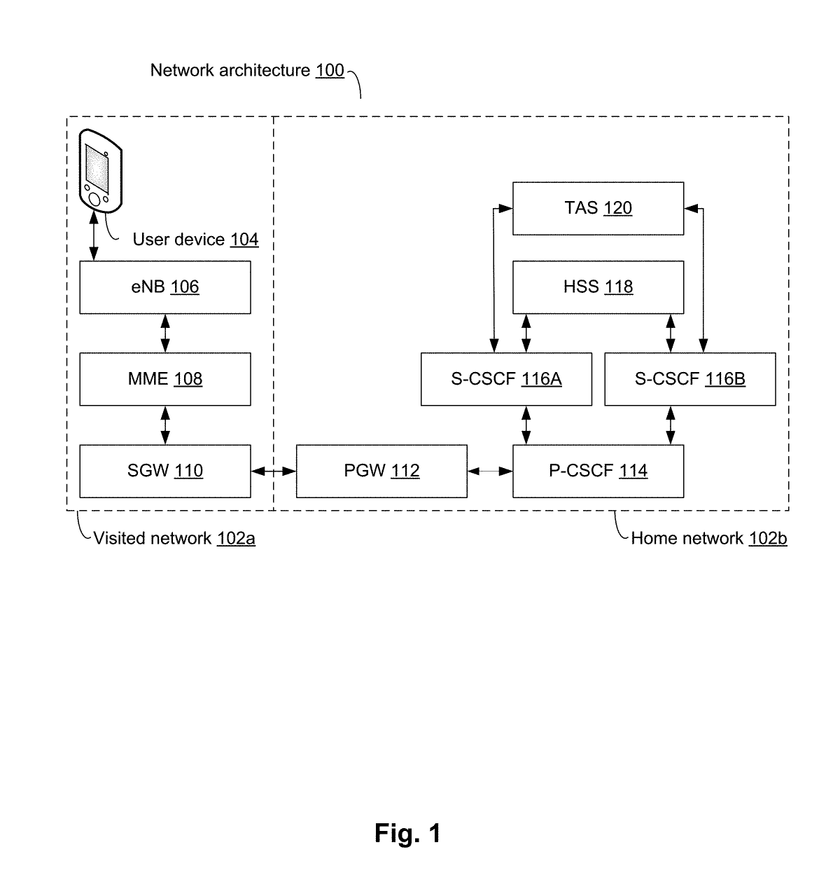

FIG. 1 illustrates a network architecture 100 for implementing the restoration of a P-Visited-Network-ID, in which a home network is configured to restore a P-Visited-Network-ID for a user device that connects to a visited network. It may be appreciated that this Figure shows an example of a network architecture, and that there may be other network architectures in which PVNI with data restoration may be implemented. As depicted, user device 104 has home network 102b, and is connected to home network 102b via visited network 102a.

Visited network 102a comprises eNB 106, MME 108, and SGW 110. eNB is a point in a telecommunications network that connects with user devices, such as user device 104. eNB 106 may send and receive wireless communications with user device 106. eNB 106 is connected with MME 108. MME 108 is configured to find, route, maintain, and transfer communications. MME 108 is configured to perform end-to-end connection signaling and security services between core networks, and to maintain connection information about user devices, and determine which gateway is to be used to connect a user device to another network. MME 108 is connected with SGW 110. SGW 110 is configured to route and forward data packets, and is configured to act as an anchor for network connectivity when user device 104 physically moves so is handed off from eNB 106 to another eNB (not shown). A user device, such as user device 104, may be associated with a single SGW, such as SGW 110, and MME 108 may determine that user device 104 will utilize SGW 110 for a current session. SGW 110 is also configured to be a point of contact for visited network 102a with home network 102b, by communicating with PGW 112 of home network 102a.

Then, home network 102b comprises PGW 112, P-CSCF 114, S-CSCF 116A, S-CSCF 116B, HSS 118, and TAS 120. PGW 112 is configured to act as an interface between home network 102a and visited network 102b (by being configured to communicate with SGW 110). Additionally, PGW 112 is configured to perform such functions as managing quality of service (QoS) for communications, performing deep packet inspection, and performing a Policy and Charging Enforcement Function (PCEF). P-CSCF 114 is connected to PGW 112.

P-CSCF 114 is—along with S-CSCF 116A, S-CSCF 116B, HSS 118, and TAS 120—part of an Internet Protocol (IP) Multimedia Subsystem (IMS; sometimes called an IP Multimedia Core Network Subsystem) that provides IP multimedia services, including voice communications. P-CSCF 114 is configured to inspect communications to the IMS, enforce policy control (such as QoS), and generate charging, or billing, records for usage of an associated user device. S-CSCF 116A and S-CSCF 116B, sometimes each referred to as a Serving-CSCF (S-CSCF) are each configured to process the location information of a user device, user device authentication, call routing, and call processing. In some embodiments, one user device will be associated with one S-CSCF at a time (e.g., S-CSCF 116A), and if that S-CSCF fails, then another S-CSCF (e.g., S-CSCF 116B) will be restored to perform the functionality of the previous S-CSCF for that user device.

HSS 118 is a master user database that contains subscriber profiles for one or more user device users that are associated with the home network, performs authentication and authorization for a user's user device, and may provide information about a user device's physical location and IP information. TAS 120 is configured to invoke recovery to a part of home network 102b in response to that part of home network 102b failing.

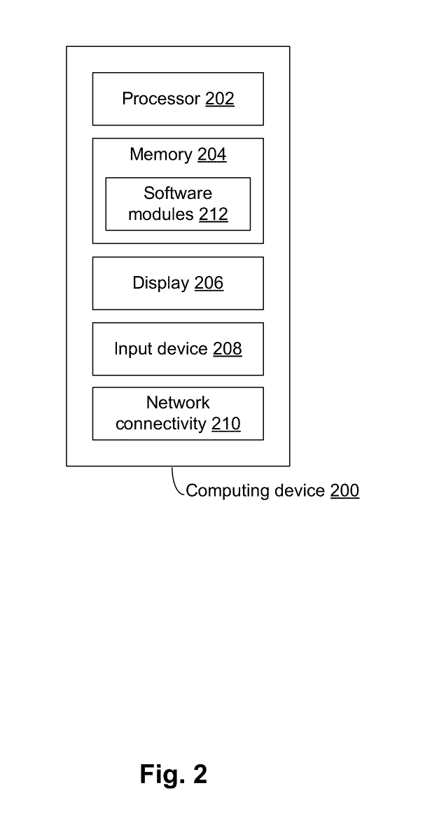

FIG. 2 is a block diagram of various components of a computing device for implementing the restoration of a P-Visited-Network-ID. As depicted, FIG. 2 contains computing device 200. In some embodiments, computing device 200 may be a user device (like user device 104 of FIG. 1) such as a cellular telephone, or a computer server. In some embodiments, computing device 200 may be used to implement Evolved Node B (eNB; sometimes referred to as E-UTRAN Node B, or eNodeB) 106, Mobile Management Entity (MME) 108, Serving Gateway (SGW) 110, Public Data Network (PDN) Gateway PGW 112, Proxy Call Session Control Function (P-CSCF) 114, S-CSCF 116A, S-CSCF 116B, HSS 118, and TAS 120 of FIG. 1.

Computing device 200 contains several components—processor 202, memory 204, display 206, input device 208, and network connectivity 210.

Processor 202 is a microprocessor, such as a central processing unit (CPU) that is configured to execute computer-executable instructions. Memory 204 may be implemented using computer-readable media, such as computer storage media, that is configured to store computer-executable instructions. Computer-readable media includes, at least, two types of computer-readable media, namely computer storage media and communications media. Computer storage media includes non-transitory volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory and/or storage technology, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

Display 206 is a display, such as a liquid crystal display (LCD), that is configured to display visual output by computing device 200. Input device 208 is computer hardware configured to receive and process user input, such as touch input, or physical buttons that a user may press, as with a mouse or keyboard. Where input device 208 is configured to receive tough input, input device 208 and display 206 may together form a touchscreen.

Network connectivity 210 may one or more radios configured to send and/or receive wireless communications. Network connectivity 210 may be configured to send and receive cellular network communications, such as via a LTE, VoLTE, or LTE-u protocol. Network connectivity 210 may also be configured to send wireless local area network communications, such as via a WiFi protocol, or another 802.11 protocol. Network connectivity 210 may also be configured to communicate via physical connection, such as via a Transmission Control Protocol/Internet Protocol (TCP/IP) protocol via an Ethernet cable.

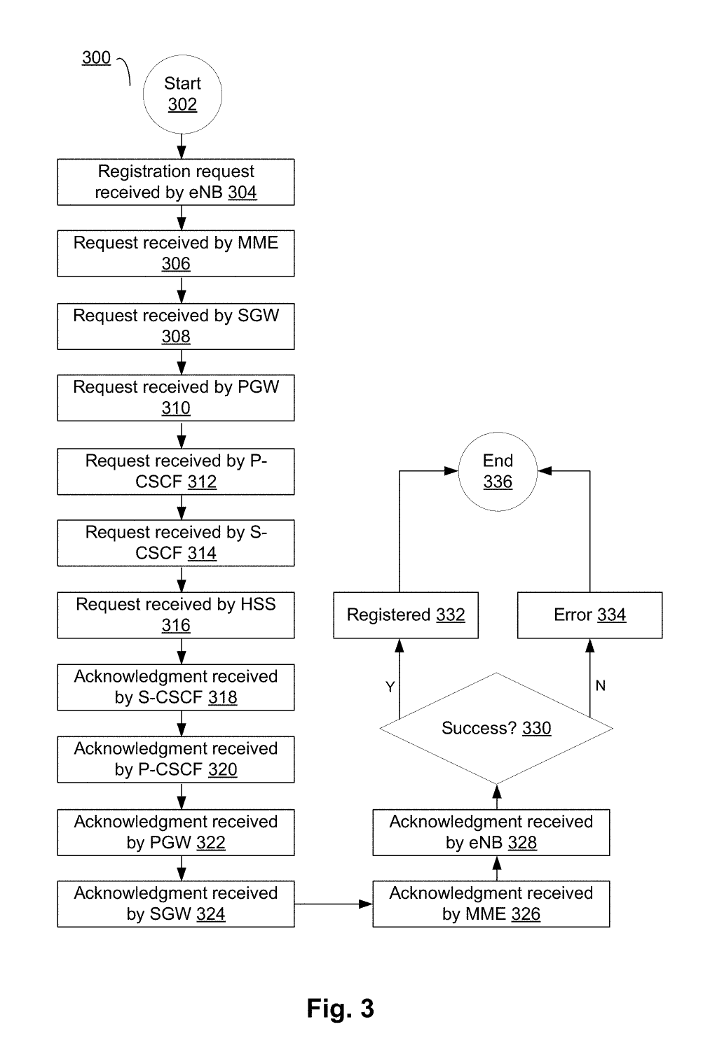

These components may be used to implement aspects of the disclosure, such as to implement the operating procedures of FIGS. 3-5. For example, computer-executable instructions corresponding to the operating procedures of at least one of FIGS. 3-5 may be stored in memory 204 and executed by processor 202 as software modules 212 and executed by processor 202. A software module is a set of computer executable instructions stored together as a discrete whole. Examples of software modules include binary executables such as static libraries, dynamically linked libraries, and executable programs. Other examples of software modules include interpreted executables that are executed on a run time such as servlets, applets, p-Code binaries, and Java binaries. Software modules include computer-executable instructions that may run in kernel mode and/or user mode.

Registering a User Device to a Network with PVNI Restoration

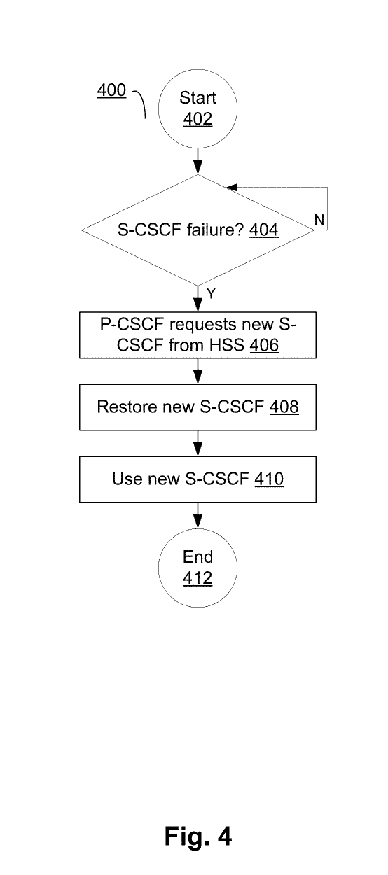

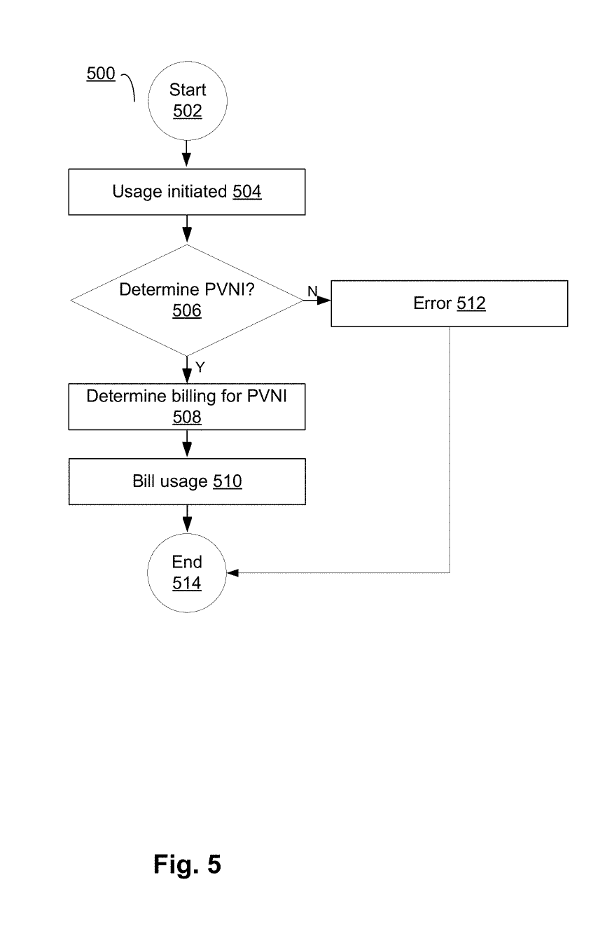

FIG. 3 depicts a flow diagram 300 of example operating procedures for a user device registering via a visited network where PVNI with data restoration is used. In some embodiments, the operating procedures of FIG. 3 (and FIGS. 4-5) may be implemented by computing device (such as through computer-executable instructions that are stored in memory 204 and executed by processor 202). It may be appreciated that the operating procedures of FIG. 3 are example operating procedures, and that there may be embodiments that implement more or fewer operations than are depicted, or that implement the operations in a different order than is depicted here.

It may be appreciated that the operating procedures of FIGS. 3-5 may be implemented in conjunction. For example, the operating procedures of FIG. 3 may be implemented to register a user device to a telecommunications network with PVNI restoration. Then, after a S-CSCF fails, the operating procedures of FIG. 4 may be implemented to restore a S-CSCF with PVNI restoration. As such, the operating procedures of FIG. 5 may be implemented to process billing for user device usage via the restored S-CSCF.

While the operating procedures of FIG. 3 (and FIGS. 4-5) generally describe a registration request originating at a user device and terminating at a HSS, and an acknowledgement of the registration request originating at the HSS and terminating at the user device, it may be appreciated that this representation is simplified for clarity. That is, multiple different types of information may be sent between various entities in the course of transmitting the registration request, or transmitting the acknowledgment, as described herein.

The operating procedures of FIG. 3 begins at 302. Operation 304 depicts an eNB receiving a registration request from a user device. In some embodiments, this eNB may be eNB 106 of FIG. 1 and this user device may be user device 104 of FIG. 1. This registration request may be initiated by the user device, and conducted via a wireless communications protocol, such as LTE. This registration request may comprise a request to attach to the telecommunications network associated with the eNB Where there is a plurality of eNBs that the user device can be in wireless communications with, the user device may send the registration request to the eNB of the plurality of eNBs that has the strongest signal available to the user device.

In the course of this communication between the user device and the eNB, the user device may send to the eNB information comprising a MCC (that identifies a country or geographical region in which the user device is located) and a MNC (that identifies a home network of the user device). After operation 304, the operating procedures of FIG. 3 move to operation 306.

Operation 306 depicts a MME receiving the registration request from the eNB. In some embodiments, this MME may comprise MME 108 of FIG. 1. In some embodiments, the eNB may forward the registration request received from the user device. For example, where the user device has sent an attach request to the eNB, the eNB may forward this attach request to the MME.

In some embodiments, operation 306 also comprises the MME sending an identity request to the user device and receiving a corresponding response, and then sending a security mode command to the user device and receiving a corresponding response. After operation 306, the operating procedures of FIG. 3 move to operation 308.

Operation 308 depicts a SGW receiving a registration request from the MME. In some embodiments, this SGW may be SGW 110 of FIG. 1. In some embodiments, the SGW may receive from the MME an identity check request that it forwards to the PGW (and that the PGW forwards to the P-CSCF). After operation 308, the operating procedures of FIG. 3 move to operation 310.

Operation 310 depicts a PGW receiving a registration request from the SGW. In some embodiments, this PGW may be PGW 112 of FIG. 1. In some embodiments, the PGW may receive from the SGW an identity check request that was originated by the MME, and the PGW may forward this identity check request to the P-CSCF.

In some embodiments, operation 310 may comprise receiving, by a home network of a telecommunications network, a request to register a user device that is originated from a visited network of the telecommunications network. After operation 310, the operating procedures of FIG. 3 move to operation 312.

Operation 312 depicts a P-CSCF receiving a registration request from the PGW. In some embodiments, this P-CSCF may be P-CSCF 114 of FIG. 1. This registration request may comprise an identity check request that was originated by the MME, and forwarded to the SGW, then to the PGW, then to the P-CSCF. In response to receiving the identity check, the P-CSCF may then send an acknowledgment of the identity check to the MME, via the PGW and the SGW. After operation 312, the operating procedures of FIG. 3 move to operation 314.

Operation 314 depicts a S-CSCF receiving a registration request from the P-CSCF. This S-CSCF may be S-CSCF 116A of FIG. 1. In some embodiments, this registration request is an authentication data request that is originated by the MME and destined for the HSS, and sent via the SGW, PGW, and P-CSCF. After operation 314 the operating procedures of FIG. 3 move to operation 316.

Operation 316 depicts a HSS receiving a registration request from the S-CSCF. This HSS may be HSS 118 of FIG. 1. In some embodiments, this registration request is an authentication data request that is originated by the, and sent via the SGW, PGW, P-CSCF, and S-CSCF. After operation 316, the operating procedures of FIG. 3 move to operation 318.

Operation 318 depicts the S-CSCF receiving an acknowledgement of the registration request from the HSS. The HSS may process the authentication data request and determine that the user device is to be authenticated to the home network. The HSS may then send an authentication data response to the S-CSCF, and that is destined for the MME. After operation 318, the operating procedures of FIG. 3 move to operation 320.

Operation 320 depicts the P-CSCF receiving an acknowledgement of the registration request from the S-CSCF. This acknowledgment of the registration request may be the authentication data response of operation 318. After operation 320, the operating procedures of FIG. 3 move to operation 322.

Operation 322 depicts the PGW receiving an acknowledgement of the registration request from the P-CSCF. This acknowledgment of the registration request may be the authentication data response of operation 318. After operation 322, the operating procedures of FIG. 3 move to operation 324.

Operation 324 depicts the SGW receiving an acknowledgement of the registration request from the PGW. This acknowledgment of the registration request may be the authentication data response of operation 318. After operation 324, the operating procedures of FIG. 3 move to operation 326.

Operation 326 depicts the MME receiving an acknowledgement of the registration request from the PGW. This acknowledgment of the registration request may be the authentication data response of operation 318. After operation 326, the operating procedures of FIG. 3 move to operation 328.

Operation 328 depicts the eNB receiving an acknowledgement of the registration request from the MME. This acknowledgment may comprise a user authentication request that is directed to the user device via the eNB. In response, the user device may send the MME a user authentication response via the eNB.

As a result of the MME receiving the user authentication response, the MME may send an update location request to the HSS, via the PGW, the P-CSCF, and the S-CSCF. This update location request may comprise information used to create a PVNI for the user device, such as a MCC and MNC. Then, the HSS may store the PVNI and send an update location acknowledgement to the MME, via the S-CSCF, the P-CSCF, the PGW, and the HSS.

The HSS may store the PVNI so that if the S-CSCF fails, when a new S-CSCF is restored to perform the functions of the prior S-CSCF, it may be restored to include the PVNI for the user device. Since the new S-CSCF has the user device's PVNI, it is able to bill the user device for usage on the visited network.

In some embodiments, operation 328 may comprise determining a PVNI for the user device that indicates a geographical area in which the user device is located. Operation 328 may also comprise storing the PVNI for the user device in a home subscriber server (HSS) of the home network. The HSS may be referred to as a location of the telecommunications network that is separate from a first S-CSCF.

Operation 328 may also comprise assigning the user device to communicate with a first S-CSCF. Operation 328 may also comprise a P-CSCF determining the PVNI for the user device based on information provided to the P-CSCF that is originated by the user device. Operation 328 may also comprise the P-CSCF sending an indication of the PVNI of the user device to the S-CSCF, which sends the indication of the PVNI for the user device to the HSS. After operation 328, the operating procedures of FIG. 3 move to operation 330.

Operation 330 depicts determining whether the registration process was successful. In some embodiments, the registration process is deemed to be successful when the user device is registered to the visited network. If in operation 330 it is determined that the registration process was successful, then the operating procedures of FIG. 3 move to operation 332. Instead, if in operation 330 it is determined that the registration process was unsuccessful, then the operating procedures of FIG. 3 move to operation 334.

Operation 332 is reached from operation 330 where it is determined in operation 330 that the registration process was successful. Operation 332 depicts determining that the user device is registered. Determining that the user device is registered may comprise determining that the user device is registered to the visited network, so that it may utilize the visited network for communications. After operation 332, the operating procedures of FIG. 3 move to 336, where the operating procedures of FIG. 3 end.

Operation 334 is reached from operation 330 where it is determined in operation 330 that the registration process was unsuccessful. Operation 334 depicts raising an error. In some embodiments, this may comprise logging that there was an unsuccessful registration attempt in a computer storage. After operation 334, the operating procedures of FIG. 3 move to 336, where the operating procedures of FIG. 3 end.

Restoring a S-CSCF on a Network with PVNI Restoration

FIG. 4 depicts a flow diagram 400 of example operating procedures for restoring a S-CSCF where PVNI with data restoration is used. In some embodiments, the operating procedures of FIG. 4 (and FIGS. 3 and 5) may be implemented by computing device (such as through computer-executable instructions that are stored in memory 204 and executed by processor 202). It may be appreciated that the operating procedures of FIG. 4 are example operating procedures, and that there may be embodiments that implement more or fewer operations than are depicted, or that implement the operations in a different order than is depicted here.

The operating procedures of FIG. 4 begins at 402, and then move to operation 404. Operation 404 depicts determining whether a S-CSCF has failed. In some embodiments, this determination may be made by a P-CSCF (such as P-CSCF 114 of FIG. 1) when it does not receive a response from the S-CSCF (such as S-CSCF 116A) within a predetermined amount of time. If it is determined in operation 404 that a S-CSCF has failed, then the operating procedures of FIG. 4 move to operation 406. Instead, if it is determined in operation 404 that a S-CSCF has not failed, then the operating procedures of FIG. 4 loop on operation 404 to monitor one or more S-CSCFs for failure.

Operation 406 is reached from operation 404 where it is determined in operation 404 that the S-CSCF has failed. Operation 406 depicts the P-CSCF requesting a new S-CSCF from the HSS. This HSS may be HSS 118 of FIG. 1. In some embodiments, operation 406 may comprise a user device making a request directed to the S-CSCF, and the P-CSCF being unable to contact the S-CSCF. In such a circumstance, the P-CSCF may indicate to the user device that the user device is to trigger a new registration. After operation 406, the operating procedures of FIG. 4 move to operation 408.

Operation 408 depicts restoring a S-CSCF. Using the system architecture of FIG. 1, it may be that S-CSCF 116A fails, and that S-CSCF 116B is restored with the data from S-CSCF 116A that is stored by HSS 118 as a result. Where the HSS has stored a PVNI for the user device, as described with respect to the operating procedures of FIG. 3, then the new S-CSCF will be restored with this PVNI. Since the new S-CSCF has the PVNI for the user device, the new S-CSCF is able to properly bill the user device for usage on the visited network.

In some embodiments, operation 408 may comprise in response to determining that the first S-CSCF has failed, restoring a second S-CSCF based on information from the HSS, including the PVNI for the user device. After operation 408, the operating procedures of FIG. 4 move to operation 410.

Operation 410 depicts using the new S-CSCF. In some embodiments, operation 410 comprises the user device interacting with the home network by communicating with the new S-CSCF. In some embodiments, operation 410 comprises assigning the user device to communicate with the second S-CSCF. After operation 410, the operating procedures of FIG. 4 move to operation 412, where the operating procedures of FIG. 4 end.

Billing User Device Usage on a Network with PVNI Restoration

FIG. 5 depicts a flow diagram 500 of example operating procedures for billing usage of a user device where PVNI with data restoration is used. In some embodiments, the operating procedures of FIG. 5 (and FIGS. 3 and 5) may be implemented by computing device (such as through computer-executable instructions that are stored in memory 204 and executed by processor 202). It may be appreciated that the operating procedures of FIG. 5 are example operating procedures, and that there may be embodiments that implement more or fewer operations than are depicted, or that implement the operations in a different order than is depicted here.

The operating procedures of FIG. 5 begins at 502, and then move to operation 504. Operation 504 depicts user device usage being initiated. In some embodiments, user device usage being initiated may comprise user device 104 of FIG. 1 sending or receiving data or other network communications (such as voice communications) via visited network 102a. After operation 504, the operating procedures of FIG. 5 move to operation 506.

Operation 506 depicts determining a PVNI. This PVNI may be determined for the user device, and may be determined by a S-CSCF of a home network of the user device. Take an example where a S-CSCF has been restored with PVNI—user device 104 of FIG. 1 originally communicated with S-CSCF 116A. Since S-CSCF 116A is the S-CSCF that the user device originally registered with, this S-CSCF has the PVNI for the user device, and can properly bill the user device's activity on the visited network. Then, if that original S-CSCF fail and a new S-CSCF be restored (S-CSCF 116B of FIG. 1), with PVNI restoration, HSS 118 restores the S-CSCF to include the PVNI for the user device. Thus, the new, restored S-CSCF may also determine the PVNI for the user device.

If in operation 506 a PVNI is determined, then the operating procedures of FIG. 5 move to operation 508. Instead, if in operation 506 a PVNI is not determined, then the operating procedures of FIG. 5 move to operation 512.

Operation 508 is reached from operation 506 where in operation 506 a PVNI is determined. Operation 508 depicts determining billing for the PVNI. In some embodiments, operation 508 may comprise the S-CSCF that corresponds to the user device determining an amount (e.g., amount of time, or amount of data) of usage by the user device, a visited network or geographical area of the user device, and a charge associated with that amount of user device usage on that mobile network. The S-CSCF may determine the visited network or geographical area of the user device based on the user device's PVNI.

In some embodiments, operation 508 comprises, in response to determining a usage for the user device, determining a charge for the usage based on the PVNI of the user device from the restored S-CSCF. After operation 508, the operating procedures of FIG. 5 move to operation 510.

Operation 510 depicts billing the user device usage. In some embodiments, operation 510 comprises the S-CSCF of operation 508 (e.g., S-CSCF 116B) storing an indication of the user device and a charge incurred in a computer memory, and may also send information such as a time at which the charge was incurred and an amount of usage associated with the charge. After operation 510, the operating procedures of FIG. 5 move to operation 514, where the operating procedures of FIG. 5 end.

Operation 512 is reached from operation 506 where it is determined in operation 506 that a PVNI is not determined. Operation 512 depicts raising an error. In some embodiments, a PVNI may not be determined because a S-CSCF was restored without PVNI restoration (and the PVNI was not stored by the HSS). This may comprise the S-CSCF logging an error to a computer memory of the home network that indicates that there is user device usage for which a PVNI is not possessed. In some embodiments of operation 512, in the absence of a PVNI, the serving network may be considered to be a home public land mobile network (HPLMN), which means that any roaming restrictions or charges are waived, and there are no service restrictions, until a PVNI is restored during a subsequent registration attempt. After operation 512, the operating procedures of FIG. 5 move to 514, where the operating procedures of FIG. 5 end.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for restoring failed server call session control function (S-CSCF) in a telecommunications network, the restoration including a P-Visited-Network-ID (PVNI), comprising:
receiving, by a home network of the telecommunications network, a request to register a user device that is originated from a visited network of the telecommunications network;
determining a PVNI for the user device that indicates a geographical area in which the user device is located;
storing the PVNI for the user device in a home subscriber server (HSS) of the home network;
assigning the user device to communicate with a first S-CSCF;
in response to determining that the first S-CSCF has failed, restoring a second S-CSCF based on information from the HSS, including the PVNI for the user device; and
assigning the user device to communicate with the second S-CSCF.

2. The method of claim 1, further comprising:
in response to determining a usage for the user device, determining a charge for the usage based on the PVNI of the user device from the restored S-CSCF.

3. The method of claim 1, further comprising:
a proxy call session control function (P-CSCF) determining the PVNI for the user device based on information provided to the P-CSCF that is originated by the user device.

4. The method of claim 1, further comprising:
the P-CSCF sending an indication of the PVNI of the user device to the first S-CSCF, the first S-CSCF sending the indication of the PVNI to the HSS.

5. The method of claim 1, wherein the PVNI comprises a mobile country code (MCC) that identifies a geographical area in which the user device is registered.

6. A system, comprising:
at least one processor; and
at least one memory communicatively coupled to the at least one processor, the at least one memory bearing processor-executable instructions that, upon execution by the at least one processor, cause the system at least to:
receive a request to register a user device to a telecommunications network;
determine a P-visited-network-Id (PVNI) for the user device;
store a PVNI for the user device in a location of the telecommunications network that is separate from a first serving call system control function (S-CSCF);
assign the user device to communicate with the first S-CSCF; and
in response to determining that the first S-CSCF has failed, restore a second S-CSCF to include the PVNI for the user device.

7. The system of claim 6, wherein the location of the telecommunications network that is separate from the first S-CSCF comprises a home subscriber server (HSS).

8. The system of claim 6, wherein the user device requests to register to a visited network, and wherein the location of the telecommunications network that is separate from the first S-CSCF is part of a home network.

9. The system of claim 6, wherein the instructions that, upon execution by the at least one processor, further cause the system at least to:
in response to determining a usage for the user device, determine a charge for the usage based on the PVNI of the user device from the restored S-CSCF.

10. The system of claim 6, wherein the instructions that, upon execution by the at least one processor, further cause the system at least to:
determine, by a proxy call session control function (P-CSCF), the PVNI for the user device based on information provided to the P-CSCF that is originated by the user device.

11. The system of claim 10, wherein the instructions that, upon execution by the at least one processor, further cause the system at least to:
send, by the P-CSCF, an indication of the PVNI of the user device to the first S-CSCF, the first S-CSCF sending the indication of the PVNI to the HSS.

12. The system of claim 6, wherein the PVNI comprises a mobile country code (MCC) that identifies a geographical area in which the user device is registered.

13. The system of claim 10, wherein the instructions that, upon execution by the at least one processor, further cause the system at least to:
assign the user device to communicate with the second S-CSCF.

14. A non-transitory computer-readable storage medium, bearing computer-executable instructions that, when executed upon a computing device, cause the computing device at least to:
receive a request to register a user device to a telecommunications network;
determine a P-visited-network-Id (PVNI) for the user device;
store a PVNI for the user device in a location of the telecommunications network that is separate from a first serving call system control function (S-CSCF); and
assign the user device to communicate with the first S-CSCF.

15. The non-transitory computer-readable storage medium of claim 14, further bearing computer-executable instructions that, when executed upon a computing device, cause the computing device at least to:
in response to determining that the first S-CSCF has failed, restore a second S-CSCF to include the PVNI for the user device.

16. The non-transitory computer-readable storage medium of claim 14, wherein the location of the telecommunications network that is separate from the first S-CSCF comprises a home subscriber server (HSS).

17. The non-transitory computer-readable storage medium of claim 14, wherein the user device requests to register to a visited network, and wherein the location of the telecommunications network that is separate from the first S-CSCF is part of a home network.

18. The non-transitory computer-readable storage medium of claim 14, further bearing computer-executable instructions that, when executed upon a computing device, cause the computing device at least to:
in response to determining a usage for the user device, determine a charge for the usage based on the PVNI of the user device from the restored S-CSCF.

19. The non-transitory computer-readable storage medium of claim 14, further bearing computer-executable instructions that, when executed upon a computing device, cause the computing device at least to:
determine, by a proxy call session control function (P-CSCF), the PVNI for the user device based on information provided to the P-CSCF that is originated by the user device.

20. The non-transitory computer-readable storage medium of claim 18, further bearing computer-executable instructions that, when executed upon a computing device, cause the computing device at least to:
send, by the P-CSCF, an indication of the PVNI of the user device to the HSS.
